(19) United States
(12) Patent Application Publication
(10) Pub. No.: US 2013/0214691 A1
(43) Pub. Date: Aug. 22, 2013

(54) Encapsulated light-emitting diode lamp

(71) Applicant: Willis Electric Co., Ltd., (US)

(72) Inventor: Johnny Chen, Taipei (TW)

(21) Appl. No.: 13/694,747

(22) Filed: Dec. 28, 2012

Related U.S. Application Data
(60) Provisional application No. 61/582,018, filed on Dec. 30, 2011.

(51) Int. Cl. H05B 33/06

(52) U.S. Cl. CPC H05B 33/06
USPC 315/192; 313/512; 313/331

(57) ABSTRACT

An overmolded light-emitting diode (LED) lamp for a decorative light string. The lamp includes a light-emitting diode, a first lead electrically connected to the light-emitting diode at a top portion of the first lead, a second lead electrically connected to the first lead through the LED, a lens encapsulating the light-emitting diode, a top portion of the first lead, and a top portion of the second lead, and a housing having a solid uniform body encapsulating a bottom portion of the lens, a portion of the first lead, and a portion of the second lead, such that bottom portions of the first lead and the second lead extend outward and away from a bottom portion of the housing.

### RELATED APPLICATION

The present application claims the benefit of U.S. Provisional Application No. 61/582,018 filed Dec. 30, 2011, which is incorporated herein in its entirety by reference.

### TECHNICAL FIELD

The present invention relates generally to light-emitting diode (LED) lamps used in decorative lighting. More particularly, the present invention relates to LED lamps formed by an over-molding process.

### BACKGROUND

LED lamps provide a source of illumination for a variety of lighting applications, including decorative lighting. Depending on the particular application, LED chips may be packaged in a number of different ways to form the LED lamp. However, most conventional LED lamps are formed of an LED chip mounted to a lead-frame structure and encapsulated in an epoxy resin lens.

Conventional lead frames include a pair of leads, or electrodes, one to serve as the anode, the other as the cathode. An LED chip is mounted to the upper portion of the cathode, and a wire bond forms an electrical connection between the LED chip and the upper portion of the anode. When a proper voltage is applied to the electrode pair, current flows through the LED, and light is produced.

Such conventional lead frames are formed by a mechanical stamping process, with the lower portion of the leads consisting of narrow metallic strips. An epoxy lens is molded onto the upper portions of the anode and cathode and over the LED itself. When such LEDs are used in traditional decorative lighting applications, such as Christmas lighting or other seasonal lighting, the LED lamp is inserted into a prefabricated socket for connection to wires of the light string. Such a known configuration is depicted in FIG. 1.

Referring to FIG. 1, an exploded view of a traditional decorative LED lamp assembly having an LED lamp 10, socket 12, and lamp holder 14, with accompanying wiring 16, is depicted. To assemble a traditional LED assembly, LED lamp 10, having leads extended away from the lens, mechanically attaches to socket 12 such that the leads extend through socket 12. Socket 12 can then couple to lamp holder 14 via a secondary mechanical attachment, again such that the leads extend, but in this step, through lamp holder 14. Finally, wires 16 can be coupled to the leads extended from LED lamp 10 through socket 12 and lamp holder 14 with a solder or mechanical fit.

Such an assembly has numerous drawbacks. The traditional assembly involves numerous individual pieces that each require separate manufacture, for example, both a molded socket 12 and a molded lamp holder 14. Further, each of the individual pieces must be subsequently assembled to form a single light assembly, as described above. This manufacture and assembly thus involves additional manufacturing time and cost. Additionally, because the mechanical fit between socket 12 and lamp holder 14 is often only an interference fit, socket 12 and lamp holder 14 are at risk of separating after being assembled.

Further, the multiple components being connected with multiple mechanical fitments and manufacturing tolerances may create an imprecise or even loose fit amongst components resulting not only in loose and unlit lamps, but potentially resulting in loose electrical connections that could cause electrical arcing and other safety concerns. A precisely-oriented downward force is typically required on LED lamp 10 in order to extend the leads through socket 12 and subsequently, lamp holder 14 without damaging the leads. With numerous apertures to thread the leads through in a traditional assembly, great caution must be taken to ensure all of the components are properly aligned and positioned so that the leads have an unabated path.

The traditional assembly therefore has a great risk of improperly extended LED leads with inadequate or unacceptable angles relative to the assembly socket 12 and lamp assembly 14. Because of these angles, the extended leads can be bent or broken during assembly. Further, the orientation of the leads relative to wiring 16 can result in improper contact between the leads and wiring 16. Improper contact between a lead and a wire terminal can result in an interrupted circuit such that when voltage is applied to the pair of terminals, light is no longer produced because the circuit is no longer completed. However, and more importantly, an air gap can result, thus leading to undesired electrical arcing and detrimental effects to the electrical components.

One solution to the traditional assembly problems of using LED lamps with decorative light strings as described above has been to insert a cover over the decorative LED lamp to protect the epoxy resin lens and subsequently mold over the base of the cover, over the LED leads and over the ends of the wires of the decorative light string. Such techniques are described in U.S. Pat. No. 7,220,022 to Allen et al. However, such a method requires not only that an additional component, a cover, be added to the lamp, but that the conductors and wires of the decorative light string be electrically and mechanically connected to the leads of the LED lamp prior to molding around the cover and wires. As a result, a user utilizing one of these methods must contend with the numerous wires hanging from each LED lamp in a light string. A tangled mess of wiring can often result, which further complicates the overmolding process. Further, LEDs, while having a lower failure rate than traditional lighting, occasionally fail. Thus, should an individual LED fail after the string is assembled, but before the overmolding process is completed, there is no way to replace the failed LED bulb, as the string has already been assembled. As a result, the entire string must be discarded.

### SUMMARY

In an embodiment, the present invention comprises a method of manufacturing an overmolded light-emitting diode (LED) lamp. The method includes: stamping out a first portion of a lead frame to form a first lead, the first lead remaining in contact with a support frame; stamping out a second portion of a lead frame to form a second lead, the second lead remaining in contact with the support frame; attaching an LED to the second lead such that the LED is electrically connected to the second lead; electrically connecting the LED to the first lead such that the first lead is in electrical connection with the second lead through the LED; encapsulating the LED and a top portion of the first lead and a top portion of the second lead, thereby forming a molded LED lens; overmolding or encapsulating a bottom portion of the LED lens, a top portion of the first lead, and a top portion of the second lead to form a lamp housing, such that bottom portions of the first lead and the second lead extend outwardly and away from the housing; and separating the lead frame from the support frame, thereby forming an individual overmolded LED lamp having a first and a second lead.

In another embodiment, the present invention comprises an overmolded light-emitting diode (LED) lamp for a decorative light string. The overmolded LED lamp comprises: a light-emitting diode; a first lead electrically connected to the light-emitting diode at a top portion of the first lead; a second lead electrically connected to the first lead through the LED; a lens encapsulating the light-emitting diode, a top portion of the first lead, and a top portion of the second lead; and a housing having a solid uniform body encapsulating a bottom portion of the lens, a portion of the first lead, and a portion of the second lead, such that bottom portions of the first lead and the second lead extend outward and away from a bottom portion of the housing. In an embodiment, the LED lens and the housing comprise the same material, which in some embodiments may be a silicone material.

In another embodiment, the present invention comprises a decorative light string. The decorative light string comprises a plurality of overmolded light-emitting diode (LED) lamps. Each of the plurality of LED lamps includes: an LED; a first lead electrically connected to the LED; a second lead electrically connected to the LED and the first lead; a lens encapsulating the LED, a top portion of the first lead, and a top portion of the second lead; and a housing having a solid uniform body encapsulating a bottom portion of the lens, a portion of the first lead, and a portion of the second lead, such that bottom portions of the first lead and the second lead extend outward and away from a bottom portion of the housing. The decorative light string also comprises a wire harness electrically connecting the power plug to the plurality of overmolded LED lamps and electrically connecting the plurality of overmolded LED lamps to each other. The decorative light string may also include a power plug for electrically connecting the light string to an external power source.

In another embodiment, the present invention comprises a method of manufacturing an overmolded light-emitting diode (LED) lamp utilizing a support frame, a crossbar, and at least one support member coupled to the crossbar at a first end and coupled to the support frame at a second end. The method includes: stamping out a first portion of a lead frame to form a first lead, the first lead remaining in contact with a crossbar; stamping out a second portion of a lead frame to form a second lead, the second lead remaining in contact with the crossbar; attaching an LED to the second lead such that the LED is electrically connected to the second lead; electrically connecting the LED to the first lead such that the first lead is in electrical connection with the second lead through the LED; encapsulating the LED, a top portion of the first lead and a top portion of the second lead, thereby forming an LED lens; crimping the first and second leads such that the first and second leads are no longer coplanar; overmolding a bottom portion of the LED lens, a top portion of the first lead, a top portion of the second lead, and a portion of the crossbar to form a lamp housing, such that bottom portions of the first lead and the second lead extend outwardly and away from the housing; and separating the lead frame from the support frame, thereby forming an individual overmolded LED lamp for use in a decorative light string.

In another embodiment, the present invention comprises a light-emitting diode (LED) lead frame set. The lead frame set comprises: a first lead frame having a first lead and a second lead; a second lead frame immediately adjacent the first lead frame, the second lead frame having a first lead and a second lead; a support structure having at least one support frame and a continuous base structure coupling the at least one support frame; a crossbar coupling the first lead frame and the second lead frame; and a plurality of sagittal supports, each sagittal support positioned along the same axis as the axes of each of the first and second leads and extending to the at least one support frame, thereby coupling the support structure to the individual leads.

Embodiments of the present invention as described above provide a number of features and benefits. In some embodiments, the overmolding process creates a simplified integrated housing for the LED lamp. A mechanical fit is no longer required between the LED lamp, socket, and lamp holder because the socket and lamp holder of traditional assemblies are chemically attached to the LED lamp via the overmolding process as a single integrated housing. Similarly, the entire assembly is stronger because of the chemical attachment of the housing to the LED lamp rather than the mechanical and interference fit connections of traditional assemblies of the socket to the lamp holder. As such, there is no chance of the LED lamp slipping out of the housing. Even if the double-encapsulated LED assembly is inserted into an additional, traditional-looking lampholder, the benefits of the lamp with integrated housing remain.

Another feature and advantage of the various embodiments of the present invention is that there are fewer discrete components to manufacture when compared to traditional assemblies. Because fewer components are required, manufacturing time and cost is lowered. Further, because the housing of the present invention is chemically attached to the LED lamp, manufacturing variation becomes less important. Unlike the variation of traditional assemblies as described above, in the present invention, there need be no worry as to how the multiple mechanical-fit components will fit together. A greater tolerance for manufacturing variation is therefore allowed by embodiments of the present invention, thus easing the burden on the manufacturer and further reducing manufacturing cost.

In another feature and advantage of the various embodiments of the present invention, the leads are guaranteed to be aligned properly after being stamped out by the mechanical stamping process. As compared with traditional assemblies, where the leads must be threaded through various components after stamping, the leads of the present invention project precisely and perpendicularly away from the lens as stamped, ready for coupling to wire terminals. Thus, the risk of improper contact between leads and wire terminals is greatly reduced, and therefore, the risk of unlighted bulbs or electrical arcing is reduced. This orientation is particularly important when the LED frame comprises wire-piercing leads. Wire-piercing leads generally comprise cutting members on the bottom portion of each lead, and thereby contact wire terminals by piercing the insulation of the respective wire such that the bottom portions of the leads make electrical contact with the wire conductors.

In another feature and advantage of the various embodiments of the present invention unlike the overmolding described in traditional assemblies, the overmolding of the present invention can be done while the LED lamp is still attached to the lead frame manufacturing support frame and before the LED or LED lamp is attached to wires of a decorative light string. In other words, a decorative light string can be created after the overmolding process, rather than before. This eliminates the possibility of numerous wires hanging in and around the areas to be overmolded, thus eliminating the need to account for these wires during the manufacturing process. Therefore, the manufacturing process is further simplified compared to traditional assembly manufacturing. Additionally, the overmolding process allows LED lamps to be made in bulk by virtue of the LED lamp being attached to the lead frame during overmolding, in contrast to the individual lamps being overmolded once a light string has been assembled, as in traditional assemblies. Further, individual overmolded LED lamps can be replaced before they are assembled into a light string, should any one of the overmolded LED lamps be defective.

In another feature and advantage of the various embodiments of the present invention, because of the overmolding of the housing, there exists an opportunity to create an installation-assisting guide in the housing. A guide can comprise a ledge, push-tab, or any other surface aiding in connection of the overmolded LED lamp with the wire terminals that is molded into the housing as part of the overmolding process. Further, the guide can be molded in a location or positioning relative to the LED lamp. Traditional assemblies that allow for an interference fit between socket 12 and lamp holder 14 at any positioning along the circumference of lamp holder 14 would therefore allow any positioning of a guide built in to lamp holder 14. However, it may be essential to have the guide in a specific position relative to the LED lamp (and leads), depending on the installation method.

### BRIEF DESCRIPTION OF THE DRAWINGS

The invention may be more completely understood in consideration of the following detailed description of various embodiments of the invention in connection with the accompanying drawings, in which:

FIG. 1 is an exploded view of a traditional LED assembly;

FIG. 2A1 is a front plan view of LED lead frames and attached manufacturing support structure, according to an embodiment of the present invention;

FIG. 2A2 is a front plan view of LED lead frames and attached manufacturing support structure, according to an embodiment of the present invention;

FIG. 2B is a front plan view of a single LED lead frame and attached manufacturing support structure, according to an embodiment of the present invention;

FIG. 2C is a front plan view of the LED lead frame and support structure of FIG. 2B with a first encapsulation, according to an embodiment of the present invention;

FIG. 2D is a front plan view of the LED lead frame and support structure of FIG. 2C with a second encapsulation, according to an embodiment of the present invention;

FIG. 2E is a front plan view of an overmolded LED lamp, according to an embodiment of the present invention;

FIG. 3 is a front plan view of an overmolded LED lamp, according to an embodiment of the present invention;

FIG. 4 is a front plan view of an overmolded LED lamp having an elongated lead frame, according to an embodiment of the present invention;

FIG. 5 is a bottom view of the overmolded LED lamp of FIG. 2E;

FIG. 6A is an exploded perspective view of an LED illumination assembly, according to an embodiment of the present invention;

FIG. 6B is a front view of the assembled LED illumination assembly of FIG. 6A;

FIG. 7 is a fragmented sectional view of the LED illumination assembly of FIG. 6B;

FIG. 8 is an overmolded LED lamp according to an embodiment of the present invention;

FIG. 9A is perspective view of LED lead frames and attached manufacturing support structure according to an embodiment of the present invention;

FIG. 9B is a front view of the LED lead frames and attached manufacturing support structure of FIG. 9A;

FIG. 9C is a side view of the LED lead frames and attached manufacturing support structure of FIG. 9A;

FIG. 10 is a perspective view of the LED lead frames and attached manufacturing support structure of FIG. 9A further including a lens;

FIG. 11 is a perspective view of the LED lead frames and attached manufacturing support structure of FIG. 10 having transverse supports removed;

FIG. 12A is a perspective view of the LED lead frames and attached manufacturing support structure of FIG. 11 having LED lead frames offset;

FIG. 12B is a front view of the LED lead frames and attached manufacturing support structure of FIG. 12A;

FIG. 12C is a side view of the LED lead frames and attached manufacturing support structure of FIG. 12A;

FIG. 13 is a perspective view of the LED lead frames and attached manufacturing support structure of FIGS. 12A-12C having housings overmolded, thereby forming overmolded LED lamps;

FIG. 14 is a perspective view of the overmolded LED lamps of FIG. 13 removed from the manufacturing support structure;

FIG. 15 is a bottom view of the overmolded LED lamp of FIG. 8;

FIG. 16 is an overmolded LED lamp according to an embodiment of the present invention;

FIG. 17A is perspective view of LED lead frames and attached manufacturing support structure according to an embodiment of the present invention;

FIG. 17B is a front view of the LED lead frames and attached manufacturing support structure of FIG. 17A;

FIG. 17C is a side view of the LED lead frames and attached manufacturing support structure of FIG. 17A;

FIG. 18 is a perspective view of the LED lead frames and attached manufacturing support structure of FIG. 17A further including a lens;

FIG. 19 is a perspective view of the LED lead frames and attached manufacturing support structure of FIG. 18 having transverse supports removed;

FIG. 20A is a perspective view of the LED lead frames and attached manufacturing support structure of FIG. 19 having LED lead frames facing each other;

FIG. 20B is a front view of the LED lead frames and attached manufacturing support structure of FIG. 20A;

FIG. 20C is a side view of the LED lead frames and attached manufacturing support structure of FIG. 20A;

FIG. 21 is a perspective view of the LED lead frames and attached manufacturing support structure of FIGS. 20A-20C having housings overmolded, thereby forming overmolded LED lamps;

FIG. 22 is a perspective view of the overmolded LED lamps of FIG. 21 removed from the manufacturing support structure;

FIG. 23 is a bottom view of the overmolded LED lamp of FIG. 16;

FIG. 24 is a side view of a parallel-connected decorative light string, according to an embodiment of the present invention;

FIG. 25 is a side view of a series-connected decorative light string, according to an embodiment of the present invention;

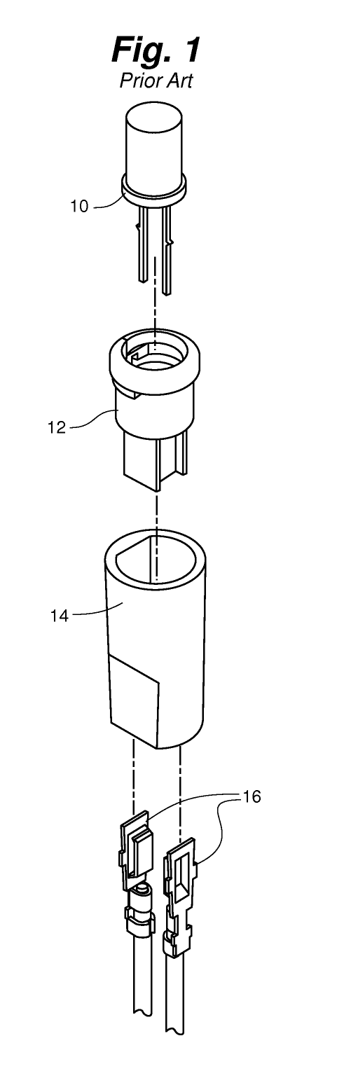

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

It is understood that embodiments of the LED lamp formed by a process of the present invention can be coupled to wire terminals via any known method. For example, leads may be coupled via a wire-piercing lead frame, a wire-clasping lead frame, or affixed to a stripped straight post via a solder or mechanical fit. However, the process as described below will be discussed based on the figures shown, which are in the context of a wire-piercing lead frame.

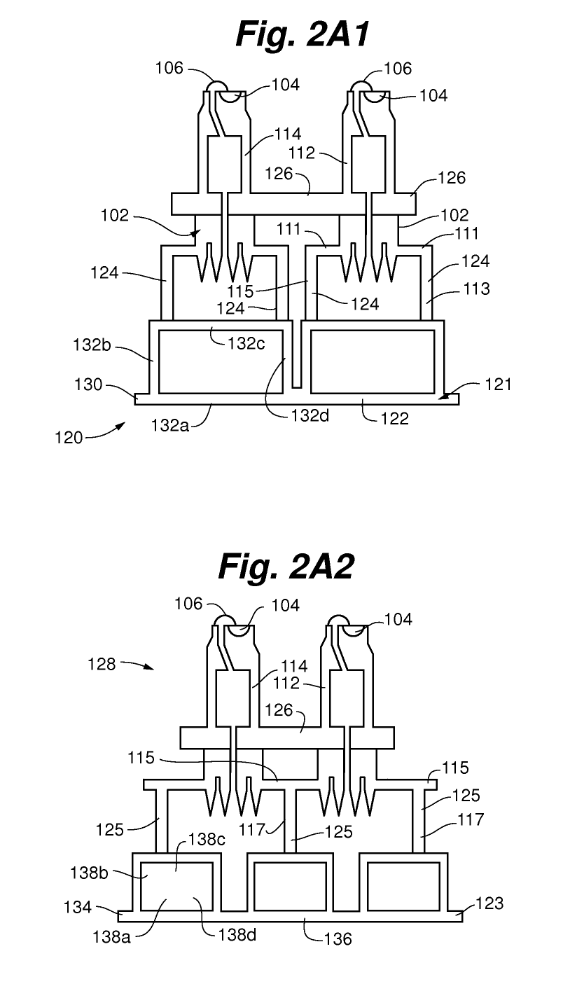

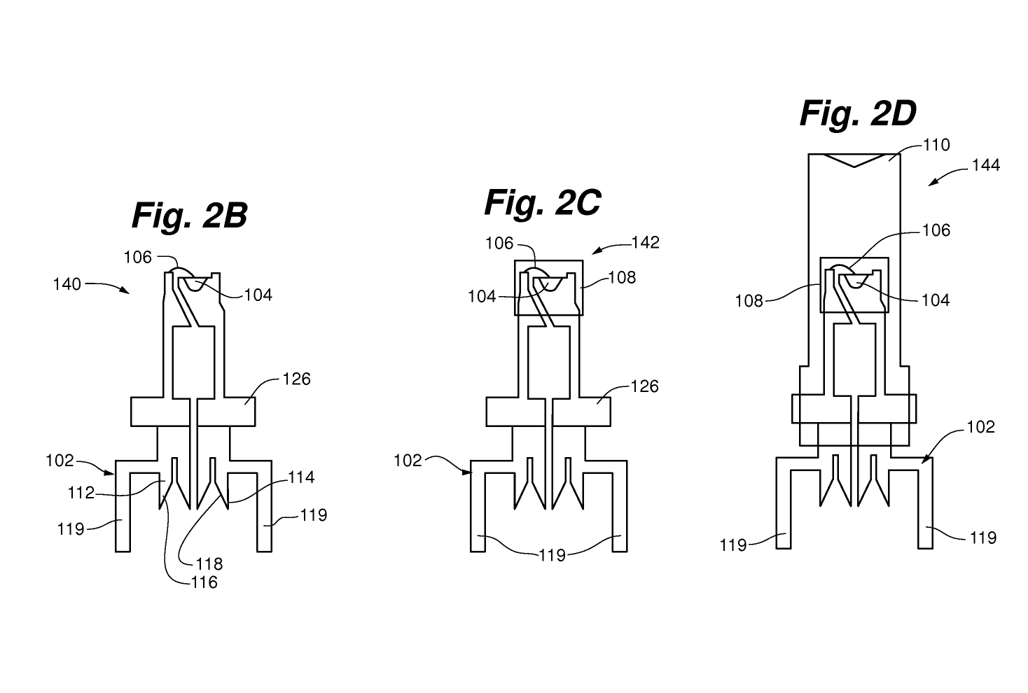

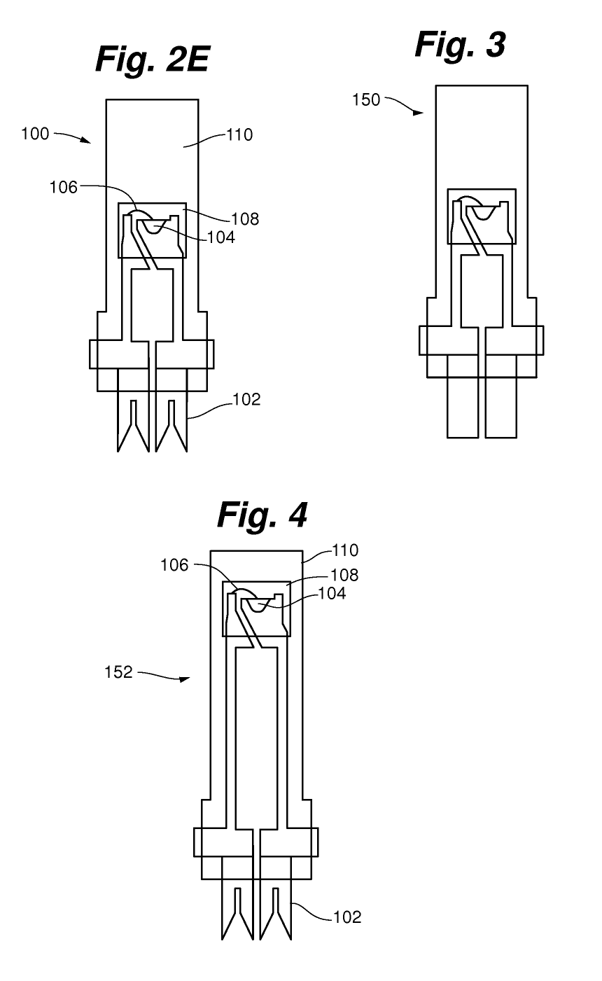

In an embodiment, referring generally to FIGS. 2A1-2E, an overmolded LED lamp 100 of the present invention is depicted. Overmolded LED lamp 100 includes lead frame 102, LED chip 104, lead-chip connector 106, lens (first encapsulation) 108, and housing (second encapsulation) 110. In some embodiments, LED lamp 100 may also include an LED chip carrier (not depicted).

In an embodiment of the present invention, lead frame 102 includes first lead 112 and second lead 114, and can be comprised of any known conductive materials, including metallic materials such as aluminum, copper, bronze, tin, or similar such conductive materials. First lead 112 and second lead 114 are separated such that leads 112 and 114 are not in direct contact with each other. As depicted in FIG. 2A1, first lead 112 and second lead 114 comprise wire-piercing leads. As such, lead 112 includes cutting member 116 along the bottom portion of lead 112, and lead 114 includes cutting member 118 along the bottom portion of lead 114. Embodiments of wire-piercing leads, lead frames and lamps are described in further detail in pending U.S. application Ser. No. 13/042,171, entitled “Wire-Piercing LED Lead Frame”, commonly assigned to the assignee of the present application, the contents of which are incorporated by reference herein in its entirety.

LED chip 104 can be one or more of any known light-emitting diode chips or dies. LED chip 104 can comprise one or more light-emitting diodes and can comprise other electronic devices within, or without the chip package. LED chip 104 may operate on AC or DC power, and at varying voltages, as will be understood by those skilled in the art. Other electronic devices can include zener diodes, other types of non-light-emitting diodes, control circuitry, as well as other electronic devices.

Lead-chip connector 106 forms an electrical connection between LED chip 104 and lead 112. In one embodiment, lead-chip connector 106 comprises wire bonding. In other embodiments, lead-chip connector 106 can comprise flip-chip, or other known technology as will be understood by those skilled in the art, to form an electrical connection between LED chip 104 and lead 112.

Lens 108 encapsulates portions of lead frame 102, LED chip 104, connector 106, and in some embodiments, the chip carrier, and comprises a transparent or semi-transparent plastic material such as an epoxy resin, or a silicone material. Lens 108 may comprise other similar materials as understood by those skilled in the art. Lens 108 is therefore a first encapsulation of all or portions of the components of lead frame 102. By encapsulating portions of lead frame 102, LED chip 104, connector 106, and in some embodiments, the chip carrier, lens 108 holds the relative positions of these components fixed, including the position of lead 112 to lead 114. It is understood that lens 108 can encapsulate all or portions of other components, including the elongated portions of lead 112 and lead 114, and greater or lesser portions of LED chip 104, connector 106, and the chip carrier, in some embodiments. Although lens 108 is depicted as comprising a generally cylindrical shape, it will be understood that lens 108 can comprise any of a variety of known shapes and sizes, as is appropriate and desired in the decorative lighting industry.

Housing 110 encapsulates portions of lead frame 102 and lens 108, and comprises a moldable material such as silicone, plastic or polymer, such as polypropylene, or other such material. In some embodiments, housing 110 may be made of a material that is the same as the material of LED lens 108, such as transparent or semi-transparent plastic material such as an epoxy resin, or a silicone material. For example, lens 108 and housing 110 may both comprise a silicone material. Housing 110 can comprise other similar materials as understood by those skilled in the art. Housing 110 is therefore a second encapsulation of all or portions of the components of lead frame 102. Therefore, housing 110 can also comprise a lamp holder that can fit into a base.

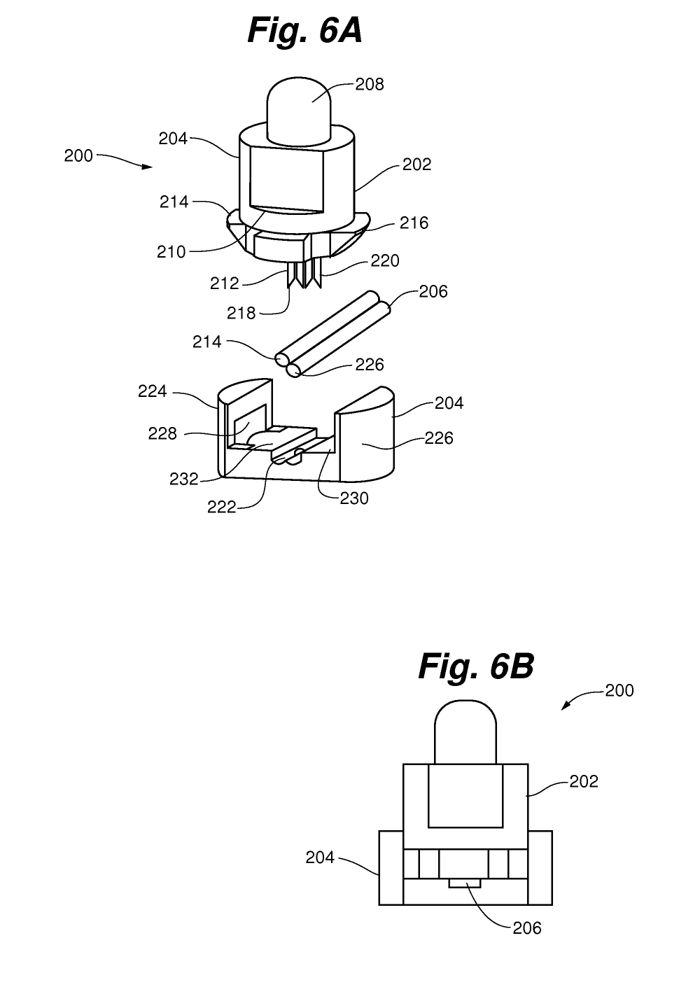

In the process described further herein, lead frame 102 is encapsulated a first time to create lens 108 and then a second time to create housing 110, via any of several molding or encapsulation processes, including injection molding, and other types of molding, including those resembling more of a dipping process, onto the LED lamp. By encapsulating portions of lead frame 102 and lens 108, housing 110 provides a solid body to support lead frame 102 and lens 108. The body of housing 110 also provides a mechanism by which wire terminals can be more easily attached to leads 112 and 114, for example, referring to FIGS. 6A and 6B, which will be explained further below.

In manufacture, referring to FIGS. 2A1, 2A2, and 2B-2E, overmolded LED lamp 100 is constructed according to an embodiment. Referring specifically to FIG. 2A1, a set 120 of lead frames 102 are depicted during an early step in manufacture. As shown, individual lead frames 102 are connected by support structure 121, testing support 119, and transverse support 126, to form a set 120 of lead frames 102. Support structure 121, testing support 119, and transverse support 126 are comprised of the same known conductive materials as lead frame 102. The foregoing support formation is generally stamped out of the same initial or preliminary mechanical stamping process or processes that form the lead frames. It is understood that each lead frame 102 of the set 120 is generally described individually with respect to its own components and supporting components, and each lead frame 102 of the set 120 has each of these respective components. Lead frame 102 has an installed LED chip 104 and lead-chip connector 106 installed by any known method as understood by those skilled in the art.

In an embodiment, referring specifically to FIG. 2A1 and set 120, testing support 119 comprises spur support 124. Spur support 124 is substantially L-shaped and provides a projection separating the components of lead frame 102 from support structure 121. As such, spur support 124 comprises crossbar member 111 and normal member 113. Crossbar member 111 of an individual spur support 124 extends from each lead 104 and 106 in a direction parallel to transverse support 126. At the distal end of crossbar member 111, normal member 113 extends from crossbar member 111 to support structure 121 in a direction generally normal to crossbar member 111 to link support structure 121 to lead frame 102. As a result, spur support 124 extends from each lead 112 and 114 in a direction parallel to transverse support 126 to link support structure 121 to lead frame 102. An individual spur support 124 thus extends from every lead 112 and 114.

In an embodiment, referring specifically to FIG. 2A2 and set 120, support structure 121 is comprised of multiple support frames 122 that individually support a single lead frame 102. Support structure 121 further comprises a continuous base structure 130 that links all support frames 122 of support structure 121.

Support frame 122, as depicted, is substantially square and positioned adjacent an individual lead frame 102. Support frame 122 is comprised of members that form a substantially square shape. Member 132a and member 132c are positioned parallel to crossbar member 111. Member 132b and member 132d are positioned orthogonal to members 132a and 132c. Thus, a substantially square shape is formed by member 132a coupling at a first end to member 132b and at a second end to member 132d, member 132b coupling at a first end to member 132a and at a second end to member 132c, member 132c coupling at a first end to member 132b and at a second end to member 132d, and member 132d coupling at a first end to member 132c and at a second end to member 132a. Along the axis of member 132a, base structure 130 couples all support frames 122 to create support structure 121, a sturdy supporting structure that connects all support frames 122 and therefore all lead frames 102. Normal members 113 are coupled to member 132c to affix support frame 122 to individual leads via individual crossbars 111.

In another embodiment, referring specifically to FIG. 2A2 and set 128, testing support 119 comprises T-shaped support 125. T-shaped support 125 is substantially T-shaped and provides a projection separating the components of lead frame 102 from support structure 123. T-shaped support 125 thus includes crossbar member 115 and normal member 117. Crossbar member 115 of an individual T-shaped support 125 extends from each lead 104 and 106 in a direction parallel to transverse support 126. As such, a second lead 106 of a first lead frame 102 are linked to a first lead 104 of a second lead frame 102 via crossbar member 115. Normal member 117 of an individual T-shaped support 125 then extends from the center of crossbar member 115 to support structure 123 in a direction normal to support structure 123 to link support structure 123 to lead frame 102. An individual T-shaped support 125 is thus positioned intermediate lead frames 102 in an adjacent set 128 of lead frames 102.

Support structure 123 is comprised of multiple support frames 136 that individually support a portion of two adjacent lead frames 102. Support structure 123 further comprises a continuous base structure 134 that links all support frames 136 of support structure 123.

Support frame 136, as depicted, is substantially square and positioned intermediate individual lead frames 102. Support frame 136 is comprised of members that form a substantially square shape. Member 138a and member 138c are positioned parallel to crossbar member 115. Member 138b and member 138d are positioned orthogonal to members 138a and 138c. Thus, a substantially square shape is formed by member 138a coupling at a first end to member 138b and at a second end to member 138d, member 138b coupling at a first end to member 138a and at a second end to member 138c, member 138c coupling at a first end to member 138b and at a second end to member 138d, and member 138d coupling at a first end to member 138c and at a second end to member 138a. Along the axis of member 138a, base structure 134 couples all support frames 136 to create support structure 123, a sturdy supporting structure that connects all support frames 136 and therefore all lead frames 102. Normal member 117 is coupled to member 138c to affix support frame 136 to individual leads via crossbar 115.

In the embodiments of sets 120 and 128, lead frame 102 is connected to each adjacent lead frame 102 by transverse support 126 such that transverse support 126 extends from first lead 112 of a first lead frame 102 through the second lead 114 of the first lead frame to first lead 112 of a second lead frame 102 and through second lead 114 of the second lead frame, and so on, forming a chain or set 120 having a uniform transverse support 126.

Referring to FIG. 2B, an individual lead frame of a set 140 of lead frames 102 are depicted without a coupled support structure 121 or 123. Likewise, transverse supports 126 are removed between every first lead 112 and second lead 114 of an individual lead frame 102, if still connected, and between second lead 114 of a first lead frame 102 and first lead 112 of a second lead frame 102. For ease of discussion, the remaining steps of manufacture are discussed herein with respect to testing support 119 generally and can embody the subsequent step from set 120 with spur support 124, or alternatively, the subsequent step from set 128 with T-shaped support 125. In embodiments, support structures 121 or 123 can remain coupled during the herein discussed manufacturing steps.

Referring to FIG. 2C, a set 4142 an individual lead frame of a set 140 of lead frames 102 are depicted during an intermediate step in manufacture. As discussed above, set 4142 comprises the set 120 of FIG. 2A1 or set 128 or FIG. 2A2, but further with lens 108 installed in a first encapsulation. Lens 108 encapsulates portions of lead frame 102, LED chip 104, and connector 106 of each lead frame 102. In some embodiments, and as understood by those skilled in the art, LED chip 104, connector 106 and portions of lead frame 102 may be coated with a phosphorous material prior to formation of lens 108. As will also be understood by those skilled in the art, portions of lead frames 102 with LED chips 104 and connectors 106 will be inserted into a cavity mold filled with lens material in a liquid form, which then may be heated and allowed to harden, thereby forming LED lens 108. Testing support 119 aids in the first encapsulation described above by providing an arm to grasp and subsequently maneuver, place, or otherwise position the set of lead frames prior to and subsequent to the encapsulation.

Referring to FIG. 2D, an individual lead frame of a set 140 a set 144 of lead frames 102 are depicted during an intermediate step in manufacture. Set 144 comprises the set 4142 of FIG. 2C, but with housing 110 overmolded in a second encapsulation to encapsulate portions of lead frame 102 and lens 108. In an embodiment, during the second encapsulation process, housing 110 is formed by inserting lens 108 and portions of lead frame 102 into a cavity (one for each LED assembly) containing the material of housing 110 in liquid form. The assembly and cavities are heated, allowed to dry and harden, thus forming housing 110 over lens 108. In one such embodiment, both LED lens 108 and housing 110 comprise silicone material. By using the same material, for example, silicone, the LED lens 108 material is less likely to melt, or to melt significantly, during the overmolding process of creating housing 110. Similar to the first encapsulation discussed above, testing support 119 aids in the second encapsulation by providing an arm to grasp and subsequently maneuver, place, or otherwise position the set of lead frames prior to and subsequent to the encapsulation.

In embodiments, in a subsequent step, LED lead frames are color-tested. In a color test, a number of lead frames under test are placed into a test fixture. In embodiments, individual lead frames are positioned in the test fixture. In other embodiments, a set of lead frames are positioned in the test fixture. In either case, testing support 119, as depicted in FIGS. 2A1-2E, comprises wider spacing and more contactable material than the individual lead frame projections themselves to provide an easily graspable and maneuverable mechanism for placing and positioning the lead frames in the test fixture. Without testing support 119, the operator would be required to grasp the individual lead frame projections, making testing difficult and time consuming. Once positioned within the test fixture, each individual LED is powered and its hue and coloring is evaluated. Subsequently, similar colors and hues are grouped together for installation on the same string. Thus, embodiments provide a testing support 119 that enables easy and efficient testing of individual or sets of LED lead frames.

Referring to FIG. 2E, an overmolded LED lamp 100 is depicted at a final step in manufacture. LED lamp 100 comprises the set 144 of FIG. 2D, but with testing support 119 removed from every first lead 112 and every second lead 114, thus creating overmolded lamp 100.

Referring to FIG. 3, it is understood that embodiments similar to lamp 100 are not limited to LED lead frames having wire piercing leads as in FIGS. 2A1-2E. Embodiments of the present invention also include LED lead frames having standard, post-like leads, or any other appropriate wire-contacting portion, such as lamp 150 as depicted in FIG. 3.

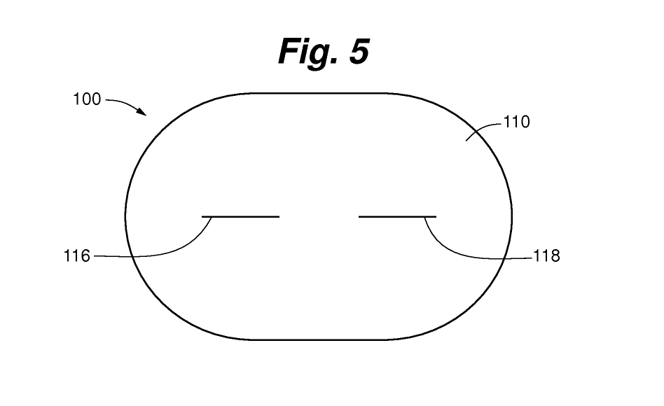

In another embodiment, referring to FIG. 4, overmolded LED lamp 152 is depicted. Overmolded LED lamp 152 is substantially the same as overmolded LED lamp 100, and is created by the substantially the same process, but comprises an elongated lead frame and elongated lens. In embodiments, an elongated lead frame and elongated lens can be used to create different lighting effects. In one such embodiment, lamp 152 has a lead frame that extends further up into the lens, such that the LED chip is located further from the housing. Moving the relative location of the LED chip provides a unique lighting effect. Referring to FIG. 5, a bottom view of the overmolded LED lamp 100 created by the steps described above in FIGS. 2A1-2E is depicted. First lead 112 is positioned in the same plane within housing 110 as second lead 114. As manufactured, a gap exists between first lead 112 and second lead 114 such that in some embodiments, parallel-running wires of a decorative light string can be placed orthogonally and subsequently coupled to first and second leads 112 and 114.

Referring to FIG. 6A, an LED illumination assembly 200 having an overmolded LED lamp 202 similar to overmolded LED lamp 100 created by the method depicted in FIGS. 2A1-2E is depicted. LED illumination assembly 200 includes overmolded LED lamp 202, housing receiver 204 and wire harness 206 having first and second side-by-side wires 234 and 236.

Overmolded LED lamp 202, as mentioned above, is substantially similar to overmolded LED lamp 100, and generally comprises an LED chip and connector situated appropriately on lead frame 218, with lens 208 and housing 209. Lens 208 encompasses LED chip and connector as described for lens 108, and housing 209 is overmolded on top of lens 208 and portions of lead frame 218, as described for overmolded LED lamp 100. Housing 209 is molded to further include ledge 210, left shoulder 214, and right shoulder 216. Ledge 210 comprises a flat horizontal top surface with an orthogonal, similarly flat, adjoining side surface that cuts into the body of housing 209. Left shoulder 214 and right shoulder 216 each form a horizontal top surface, an opposite bottom surface and inward angling side surfaces that connect the top surface to the bottom surface. Lead frame 212 is substantially similar to lead frame 102 as discussed above, with lead frame 212 having a first lead 218 and a second lead 220 separated such that leads 218 and 220 are not in direct contact with each other

Housing receiver 204 generally includes vertical left sidewall 224 and right sidewall 226. Housing receiver 204 also defines left shoulder-receiving recess 228, right shoulder-receiving recess 230, bottom surface 232, and wire channels 222. A distance from an inside surface of left sidewall 224 to an inside surface of right sidewall 226, in an embodiment, is less than a distance from a leftmost portion of left shoulder 214 to a rightmost portion of right shoulder 216.

In FIG. 6A, wire harness 206 comprises a first wire 234 and a second wire 236, with first and second wires 234 and 236 positioned parallel and immediately adjacent each other.

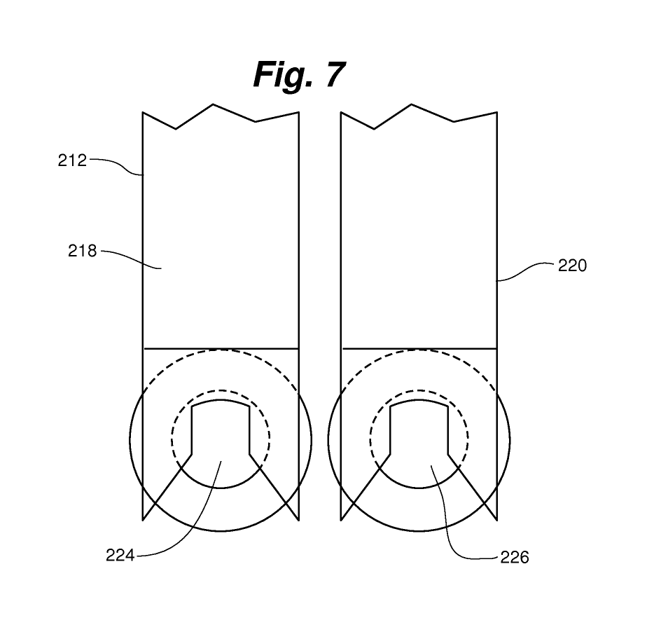

In assembling LED illumination assembly 200, referring to FIGS. 6A, 6B, and 7, overmolded LED lamp 202 is inserted into housing receiver 204. Wires 234 and 236 are likewise inserted into housing receiver 204 by being received by wire channels 222 prior to overmolded LED lamp insertion, and held securely in place when overmolded LED lamp 202 is fitted to housing receiver 204. Ledge 210 can be used to hold and position housing 209 relative to housing receiver 204 during assembly. For example, a tool or human digit can be positioned on ledge 210, which provides a larger surface for downward force than the other exposed surfaces of housing 209. As overmolded LED lamp 202 is forced downward into housing receiver 204, left sidewall 224 bends or flexes outwardly away from center to allow left shoulder 214 to align with, and be received by, left shoulder-receiving recess 228. Similarly, right sidewall 226 bends or flexes outwardly away from center to allow right shoulder 216 to align with, and be received by, right shoulder-receiving recess 230. The receiving of shoulders 214 and 216 into their respective recesses 228 and 230 forms a tight fit between overmolded LED lamp 202 and housing receiver 204. When overmolded LED lamp 202 is fit into housing receiver 204, portions of the bottom surface of housing receiver 204, specifically housing 209, are adjacent the wires 206 and top surface 232 of housing receiver 204, and apply a downward force to the wire harness 206 and top surface 232.

Referring specifically to FIG. 7, cutting members on each respective end of first lead 218 and second lead 220 pierce the insulation of wires 234 and 236, respectively, when overmolded LED lamp 202 is fully inserted into housing receiver 204. Thus, a direct contact is made between first lead 218 and the conductive portion of first wire 234, and similarly, between second lead 220 and the conductive portion of second wire 236, creating an electrical circuit.

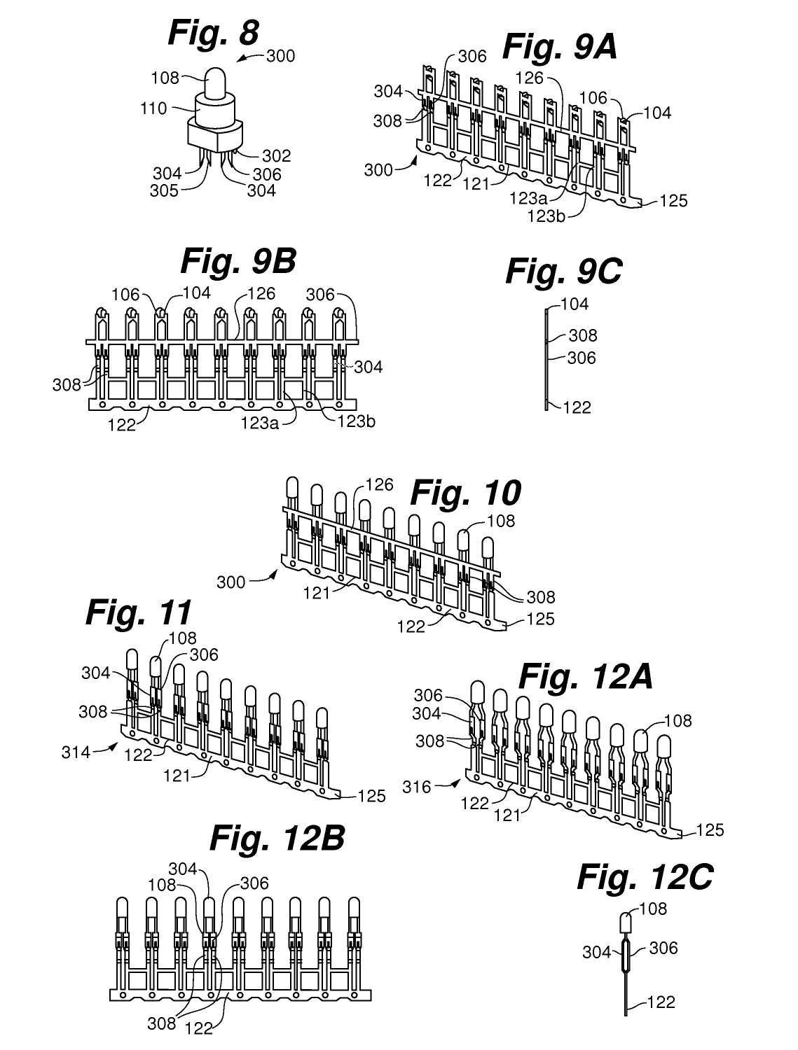

In another embodiment, referring to FIG. 8, overmolded LED lamp 300 is depicted. Overmolded LED lamp 300 is substantially the same as overmolded LED lamp 100 and manufactured via the similar process as overmolded LED lamp 100, with differences described herein.

Overmolded LED lamp 300 includes lead frame 302, LED chip 104, lead-chip connector 106, lens 108, and housing 110. In some embodiments, overmolded LED lamp 300 may also include an LED chip carrier (not depicted).

Lead frame 302 includes first lead 304 and second lead 306, and can be comprised of any known conductive materials, including metallic materials such as aluminum, copper, bronze, tin, or similar such conductive materials. First lead 304 and second lead 306 are separated such that leads 304 and 306 are offset and oblique to each other, as will be described herein during the manufacturing process. As depicted in FIG. 8, first lead 304 and second lead 306 comprise wire-piercing leads. As such, lead 304 includes cutting member 305 along the bottom portion of lead 304, and lead 306 includes cutting member 307 along the bottom portion of lead 306. However, it will be understood that the present invention is not limited to LEDs having wire piercing leads. Embodiments of the present invention also include LEDs having standard, post-like leads.

In manufacture, referring to FIGS. 9A-14, overmolded LED lamp 300 is constructed according to an embodiment. Referring specifically to FIGS. 9A-9C, a set 310 of lead frames 302 are depicted during an early step in manufacture. As shown, individual lead frames 302 are connected by support structure 121, sagittal support 308, and transverse support 126, to form a set 310 of lead frames 302. Support structure 121, sagittal support 308, and transverse support 126 are comprised of the same known conductive materials as lead frame 302. The foregoing support structure is generally stamped out of the same initial or preliminary mechanical stamping process or processes that form the lead frames. It is understood that each lead frame 302 of the set 310 is generally described individually with respect to its own components and supporting components, and each lead frame 302 of the set 310 has each of these respective components. Lead frame 302 has an installed LED chip 104 and lead-chip connector 106 installed by any known method as understood by those skilled in the art.

Lead frame 302 is connected to each adjacent lead frame 302 by transverse support 126 such that transverse support 126 extends from first lead 304 of a first lead frame 302 through the second lead 306 of the first lead frame to first lead 304 of a second lead frame 302 and through second lead 306 of the second lead frame, and so on, forming a chain or set 310 having a uniform transverse support 126.

Sagittal support 308 is substantially rectangular and provides a projection separating the components of lead frame 302 from support frame 122. Sagittal support 308 extends from each lead 304 and 306 in a direction orthogonal to transverse support 126 to link support structure 121 to lead frame 302. An individual sagittal support 308 thus extends from every lead 304 and 306.

Support structure 121 is comprised of multiple support frames 122 that individually support a portion of two adjacent lead frames 102. Support structure 121 further comprises a continuous base structure 125 that links all support frames 122 of support structure 121.

Support frame 122 is substantially H-shaped and positioned intermediate individual lead frames 302 in substantially similar manner as lead frames 102. Specifically, a first prong 123a of the H of a first support frame 122 is attached to the sagittal support 308 of second lead 302 of a first lead frame 302. A second prong 123b of the same first support frame 122 is attached to the sagittal support 308 of first lead 304 of a second lead frame 302. A first prong 123a of a second support frame 122 is then attached to the sagittal support 308 of a second lead 306 of second lead frame 302, and so on, to form set 310. The opposing prongs of support frames 122 are all connected similar to transverse support 126 to create a sturdy supporting structure that connects all support frames 122 and therefore all lead frames 302.

Referring to FIG. 10, a set 312 of lead frames 302 are depicted during an intermediate step in manufacture. Set 312 comprises the set 310 of FIGS. 9A-9C, but further with lens 108 installed. Lens 108 encapsulates portions of lead frame 302, LED chip 104, and connector 106 of each lead frame 302 as described with respect to lead frame 102.

Referring to FIG. 11, a set 314 of lead frames 302 are depicted during an intermediate step in manufacture. Set 314 comprises the set 312 of FIG. 13, but with transverse support 126 removed between every first lead 304 and second lead 306 of an individual lead frame 302 and between second lead 306 of a first lead frame 302 and first lead 304 of a second lead frame 302. Support frames 122, via sagittal supports 308 comprise the structure joining individual lead frames 302 to adjacent lead frames 302. Continuous base structure 125 continues to couple support frames 122.

Referring to FIGS. 12A-12C, a set 316 of lead frames 302 are depicted during an intermediate step in manufacture. Set 316 comprises the set 314 of FIG. 11, but with sagittal supports 308 crimped along the axis previously created by transverse support 126 and also crimped along the axis orthogonal to the axis previously created by transverse support 126. It is understood by one skilled in the art that the crimping referred to in this and other embodiments can also refer to bending, torquing, shifting, moving, or any other appropriate flexure. The sagittal support 308 coupled to first lead 304 is crimped away from second lead 306 along the axis previously created by transverse support 126. Similarly, the sagittal support 308 coupled to second lead 306 is crimped away from first lead 304 along the axis previously created by transverse support 126. Additionally, the sagittal support 308 coupled to first lead 304 is crimped away from second lead 306 along the axis orthogonal to the axis previously created by transverse support 126. Similarly, in an embodiment the sagittal support 308 coupled to second lead 306 is crimped away from first lead 304 along the axis orthogonal to the axis previously created by transverse support 126. In other embodiments, only one lead is crimped. In effect, between manufacturing steps of sets 314 and 316, leads 304 and 306 transition from being adjacent and in the same plane, to being offset and oblique to each other. Referring specifically to FIG. 12C, first lead 304 and second lead 306 are shown to be in separate, but parallel planes.

Referring to FIG. 13, a set 318 of lead frames 302 are depicted during an intermediate step in manufacture. Set 318 comprises the set 316 of FIGS. 12A-12C, but with housing 110 overmolded to encapsulate portions of lead frame 302 and lens 108. Housing 110 is overmolded according to methods known by persons skilled in the art, as discussed above.

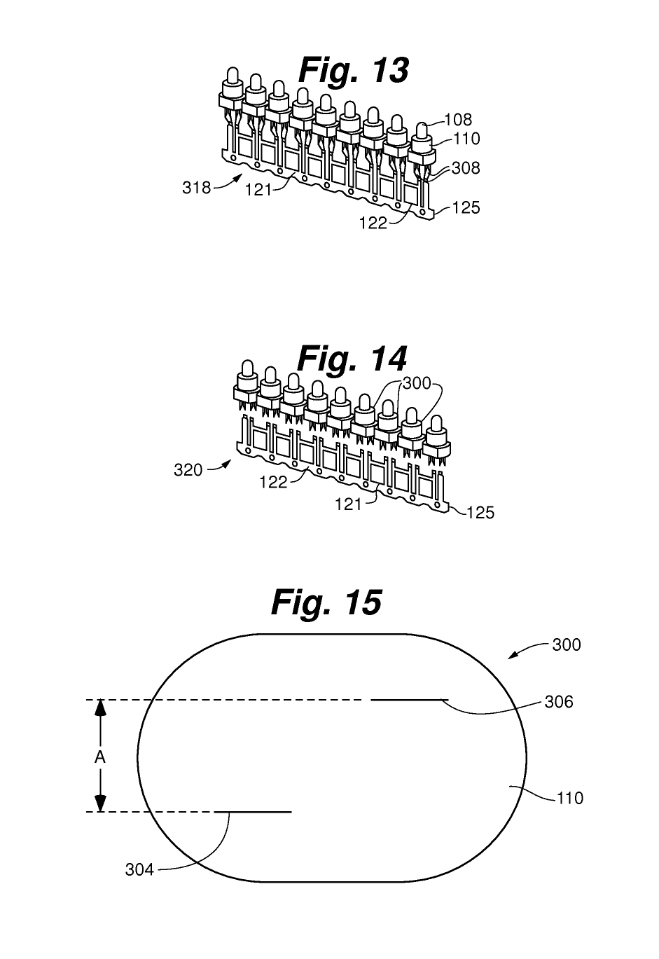

Referring to FIG. 14, a set 320 of overmolded LED lamps 300 are depicted at a final step in manufacture. Set 320 comprises the set 318 of FIG. 13, but with now-crimped sagittal support 308 removed between every first lead 304 and support frame 122 and every second lead 306 and support frame 122. Thus, numerous individual overmolded LED lamps 300 are produced.

Referring to FIG. 15, a bottom view of the overmolded LED lamp 300 created by the steps described above in FIGS. 9A-14 is depicted. First lead 304 and second lead 306 are positioned in different planes within housing 110 such that an offset A is created between the parallel planes. The offset A combined with the oblique positioning of leads 304 and 306 allow for parallel-running wires to be placed orthogonally, and subsequently coupled to, first and second leads 304 and 306 in certain wiring applications in order to create a circuit.

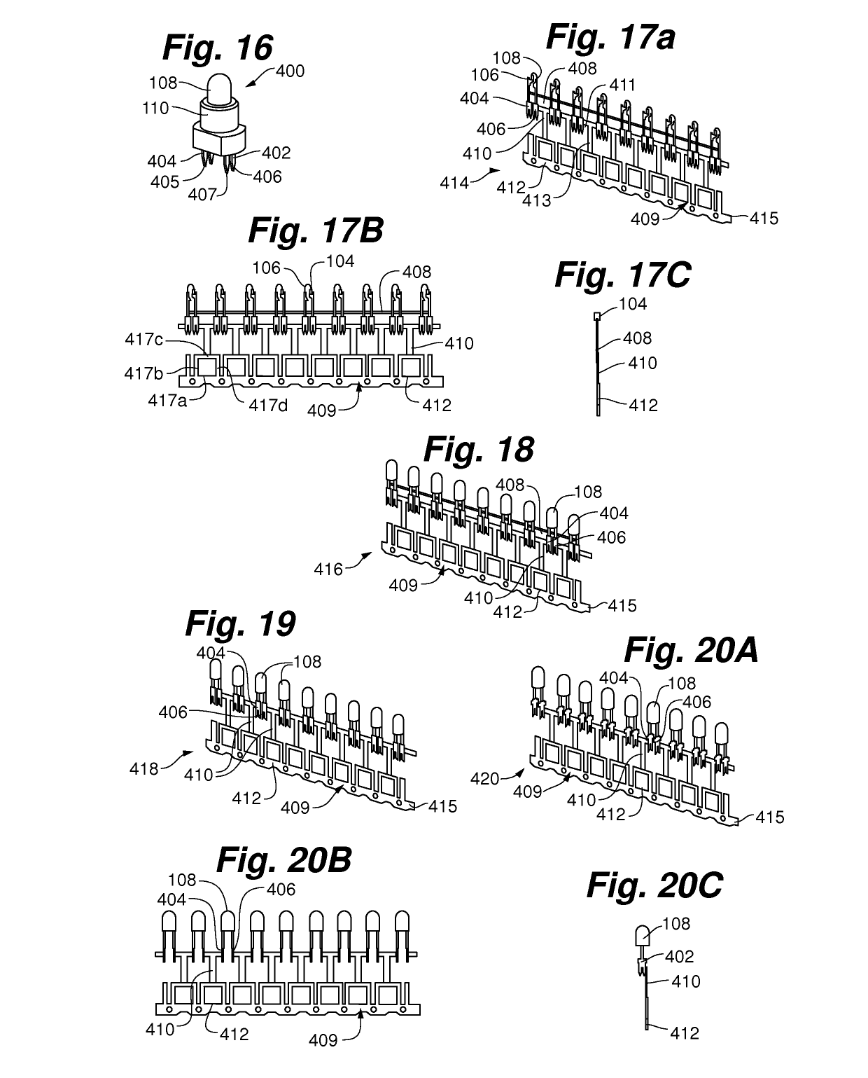

In another embodiment, referring to FIG. 16, overmolded LED lamp 400 is depicted. Overmolded LED lamp 400 is substantially the same as overmolded LED lamp 100 and overmolded LED lamp 300 and manufactured via similar processes as overmolded LED lamp 100 and overmolded LED lamp 300, with differences described herein.

Overmolded LED lamp 400 includes lead frame 402, LED chip 104, lead-chip connector 106, lens 108, and housing 110. In some embodiments, LED lamp 400 may also include an LED chip carrier (not depicted).

Lead frame 402 includes first lead 404 and second lead 406, and can be comprised of any known conductive materials, including metallic materials such as aluminum, copper, bronze, tin, or similar such conductive materials. First lead 404 and second lead 406 are separated such that leads 404 and 406 are opposite each other such that they have faces opposing each other and are not in direct contact with each other, as will be described herein during the manufacturing process. Such an embodiment may be used in a series-connected decorative light string as discussed further below. As depicted in FIG. 16, first lead 404 and second lead 406 comprise wire-piercing leads. As such, lead 404 includes cutting member 405 along the bottom portion of lead 404, and lead 406 includes cutting member 407 along the bottom portion of lead 406.

In manufacture, referring to FIGS. 17A-22, overmolded LED lamp 400 is constructed according to an embodiment. Referring specifically to FIGS. 17A-17C, a set 414 of lead frames 402 are depicted during an early step in manufacture. As shown, individual lead frames 402 are connected by support structure 415, T-shaped support 410, and transverse support 408, to form a set 414 of lead frames 402. Support structure 415, T-shaped support 410, and transverse support 408 are comprised of the same known conductive materials as lead frame 402. The foregoing support structure is generally stamped out of the same initial or preliminary mechanical stamping process or processes that form the lead frames. It is understood that each lead frame 402 of the set 414 is generally described individually with respect to its own components and supporting components, and each lead frame 402 of the set 414 has each of these respective components. Lead frame 402 has an installed LED chip 104 and lead-chip connector 106 installed by any known method as understood by those skilled in the art.

Lead frame 402 is connected to each adjacent lead frame 402 by transverse support 408 such that transverse support 408 extends from first lead 404 of a first lead frame 402 through the second lead 406 of the first lead frame to first lead 404 of a second lead frame 402 and through second lead 406 of the second lead frame, and so on, forming a chain or set 414 having a uniform transverse support 408.

T-shaped support 410 is substantially T-shaped and provides a projection separating the components of lead frame 402 from support structure 409. T-shaped support 410 thus includes crossbar member 411 and normal member 413. Crossbar member 411 of an individual T-shaped support 410 extends from each lead 404 and 406 in a direction parallel to transverse support 408. As such, a second lead 406 of a first lead frame 402 are linked to a first lead 404 of a second lead frame 402 via crossbar member 411. Normal member 413 of an individual T-shaped support 410 then extends from the center of crossbar member 411 to support structure 409 in a direction normal to support structure 409 to link support structure 409 to lead frame 402. An individual T-shaped support 410 is thus positioned intermediate lead frames 402 in an adjacent set 414 of lead frames 402.

Support structure 409 is comprised of multiple support frames 412 that individually support a portion of two adjacent lead frames 402. Support structure 409 further comprises a continuous base structure 415 that links all support frames 412 of support structure 409.

Support frame 412, as depicted, is substantially square and positioned intermediate individual lead frames 402 in a substantially similar manner as lead frames 102 and 302.

Support frame 412 is comprised of members that form a substantially square shape. Member 417a and member 417c are positioned parallel to crossbar member. Member 417b and member 417d are positioned orthogonal to members 417a and 417c. Thus, a substantially square shape is formed by member 417a coupling at a first end to member 417b and at a second end to member 417d, member 417b coupling at a first end to member 417a and at a second end to member 417c, member 417c coupling at a first end to member 417b and at a second end to member 417d, and member 417d coupling at a first end to member 417c and at a second end to member 417a. Along the axis of member 417a, base structure 415 couples all support frames 412 to create support structure 409, a sturdy supporting structure that connects all support frames 412 and therefore all lead frames 402. Normal member 413 is coupled to member 417c to affix support frame 412 to individual leads via crossbar 411.

Referring to FIG. 18, a set 416 of lead frames 402 are depicted during an intermediate step in manufacture. Set 416 comprises the set 414 of FIGS. 17A-17C, but further with lens 108 installed. Lens 108 encapsulates portions of lead frame 402, LED chip 104, and connector 106 of each lead frame 402 as described with respect to lead frame 102.

Referring to FIG. 19, a set 418 of lead frames 402 are depicted during an intermediate step in manufacture. Set 418 comprises the set 416 of FIG. 18, but with transverse support 408 removed between every first lead 404 and second lead 406 of an individual lead frame 402 and between second lead 406 of a first lead frame 402 and first lead 404 of a second lead frame 402. Support frames 412, via T-shaped supports 410 comprise the structure joining individual lead frames 402 to adjacent lead frames 402. Continuous base structure 415 continues to couple support frames 412.

Referring to FIGS. 20A-20C, a set 420 of lead frames 402 are depicted during an intermediate step in manufacture. Set 420 comprises the set 418 of FIG. 19, but with first lead 404 and second lead 406 twisted about the axis of normal member 413. First lead 404 is twisted 90 degrees about the axis of normal member 413 of T-shaped support 410 to which it is attached. Similarly, second lead 406 is twisted 90 degrees about the axis of normal member 413 of T-shaped support 410 to which it is attached, but in the opposite direction as first lead 404. Thus, first lead 404 and second lead 406 are then positioned with respective faces opposing each other. Referring specifically to FIG. 20C, lead frame 402 is shown to be orthogonal to T-shaped support 410 rather than in the same plane, with first lead 404 and second lead 406 facing each other.

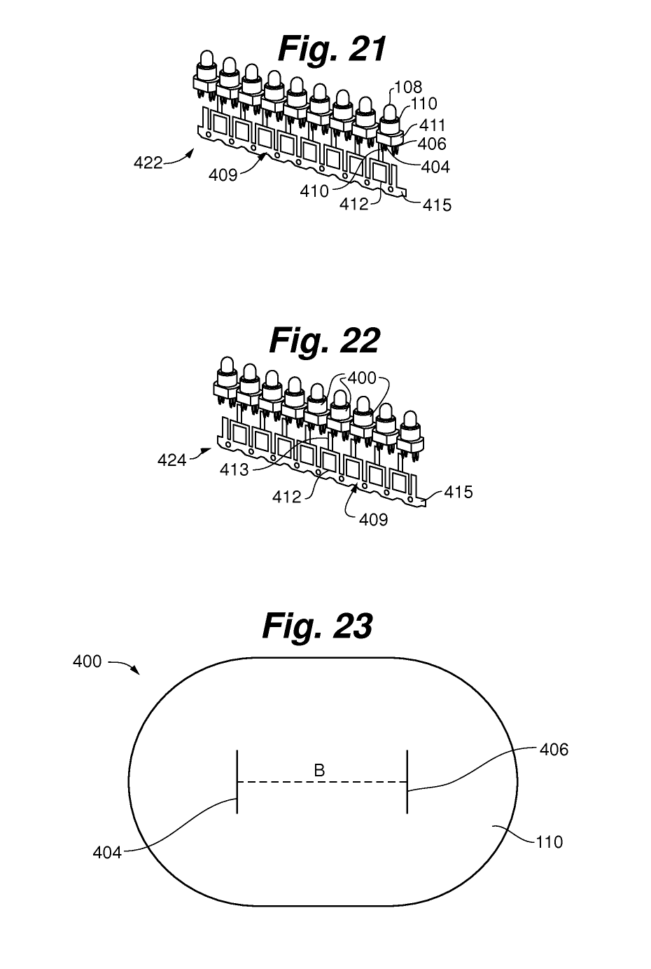

Referring to FIG. 21, a set 422 of lead frames 402 are depicted during an intermediate step in manufacture. Set 422 comprises the set 420 of FIGS. 20A-20C, but with housing 110 overmolded to encapsulate portions of lead frame 402 and lens 108. Housing 110 is overmolded according to methods known by persons skilled in the art, as discussed above.

Referring to FIG. 22, a set 424 of overmolded LED lamps 400 are depicted at a final step in manufacture. Set 424 comprises the set 422 of FIG. 21, but with crossbar member 411 removed from each set of first lead 404 and second lead 406. Only normal member 413 remains of T-shaped support 410, and therefore, T-shaped support and support frame 412 are no longer coupled to lead frames 402. Thus, numerous individual overmolded LED lamps 400 are produced.

Referring to FIG. 23, a bottom view of the overmolded LED lamp 400 created by the steps described above in FIGS. 17A-22 is depicted. First lead 404 and second lead 406 are positioned in different planes and opposite each other within housing 110 such that a gap B is created between the parallel planes. Gap B allows for a single wire, with an appropriate gap in the wire, between first and second leads 404 and 406, to be placed orthogonally, and subsequently coupled to, first and second leads 404 and 406 in an electrically series-connected decorative light string.

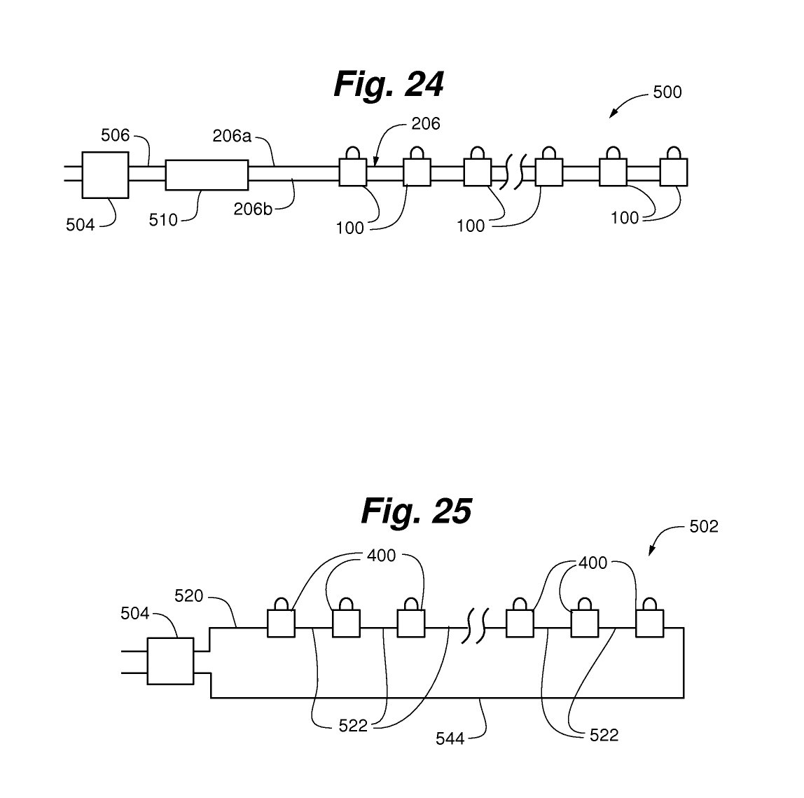

Referring to FIGS. 24 and 25, various embodiments of the overmolded LED lamps described above, including lamps 100, 150, 152, 200, 300, or 400 can be used to form a decorative light string, such as depicted decorative light strings 500 and 502.

Referring specifically to FIG. 24, decorative light string 500 is depicted. Decorative light string 500 includes optional power plug 504, wire harness 505 and a plurality of overmolded LED lamps 100. Wire harness 505 includes lead wires 506 and a pair of side-by-side wires, first wire 507 and second wire 509. In an embodiment, decorative light string 500 may also include a power transformer, also known as a power adapter or converter, 510. Further, it will be understood that although decorative light string 500 is depicted as including overmolded lamps 100, other overmolded LED lamps may be used, including lamps 150, 152, 200, 300, or 400 with or without additional housing assemblies.

Power is received from an external source via optional power plug 504. Although a conventional power plug 504 is depicted, in some embodiments, such as a decorative light string adapted for a particular lighted artificial tree, such a power plug 504 may not be present. In such an embodiment, decorative light string 500 may be otherwise connected to a power bus or other external source of power.

If power transformer 510 is present, power may be reduced from a higher voltage to a lower voltage. In an embodiment, power transformer 510 reduces incoming AC voltage to a DC voltage appropriate for LED lamp 100. In one such embodiment, power transformer reduces 120VAC power to 3VDC power. Lead wires 506 electrically connect power plug 504 to transformer 510.

Wire harness 505, via first wire 507 and second wire 509 electrically connect transformer 510 to the first overmolded LED lamp 100, and to each subsequent overmolded LED lamp 100. In the embodiment depicted, overmolded LED lamps 100 are electrically connected in parallel, such that decorative light string 500 comprises a parallel-configured light string. Lamps 100, 150, 152, 200, 300, and 400 as described above include leads with bottom portions extending from their respective housings. The protruding leads are adapted for use with side-by-side, or parallel, wires 507 and 509. For example, the embodiments depicted in FIGS. 2A1-3 are intended for decorative light strings electrically connected in parallel, similar to parallel-configured decorative light string 500. Although same-plane wire construction having side-by-side leads is depicted, the embodiments of LED frames and LED lamps created therefrom can also be implemented in crimped and offset leads in different planes, or twisted leads in opposing planes, among others. As a result, the embodiments of FIGS. 2A1-3, as well as the other above-described embodiments are also useful in series-connected decorative light strings. As also described above, each lead of a lamp 100 pierces one of wires 507 and 509 to form an electrical connection across lamp 100 from first wire 507 to second, adjacent wire 509.

A method of manufacturing decorative light string 500 includes providing a first wire 507 and a second wire 509, the wires adjacent one another, and attaching each of a plurality of overmolded LED lamps 100 onto first and second wires 507 and 509, such that a first lead of each lamp 100 pierces first wire 507 and a second lead pierces a second wire 509. The step of attaching each lamp 100 to wires 507 and 509 may include the steps of inserting wires 507 and 509 into channels defined by a receiver 204, followed by applying a force to shoulders 214 and 216 causing lamp 100 to move in a direction toward wires 507 and 509, such that the leads of lamp 100 pierce the insulation of the wires 507 and 509 and contact their respective wire conductors.

In operation, when power plug 504 is plugged into an external power source, power is provided to each of overmolded LED lamps 100, thus causing lamps 100 to emit light when powered.

Referring to FIG. 25, a series-connected light string 502 is depicted. Light string 502 includes optional power plug 504, wire harness 518, which includes lead wire 520, a plurality of interconnecting wires 522, and return wire 524, and a plurality of overmolded LED lamps 400.

In this configuration, light string 502 employs lamps 400, each lamp having first and second leads extending from their housings to form a pair of parallel planes, such that the leads are opposite one another (refer also to FIG. 23). As such, overmolded LED lamps 400 are adapted to be electrically connected with a gapped single wire (otherwise described as a pair of wire segments 522 arranged along a, common axis), rather than a pair of wires 507, 509 with continuous conductors arranged along two parallel axes, by piercing the insulative portion of wire 522 and contacting the conductive portion of wire 522 in a manner similar to that depicted in FIG. 7. As such lamp 400 is especially configured or adapted to manufacture series-connected decorative light strings, such as light string 502.

Power plug 504 is electrically connected to first lamp 400 via lead wire 520. Interconnecting wires electrically connect each of overmolded LED lamps 400 in electrical series. Return wire 544 electrically connects the last LED lamp 400 in the series to power plug 504.

A method of manufacturing decorative light string 502 includes providing a first wire 522 and a second wire 522 lying along a common axis and forming a gap between each of the first and second wires 522, and attaching each of a plurality of overmolded LED lamps 400 onto first and second wires 522, such that a first lead of each lamp 100 pierces first wire 522 and a second lead pierces a second wire 522. The step of attaching each lamp 400 to wires 522 may include the steps of inserting an end of each of wire 522 into a channel defined by a receiver 204, followed by applying a force to shoulders 214 and 216 causing lamp 400 to move in a direction toward wires 206a and 206b, such that the leads of lamp 400 pierce the insulation of the wires and contact the wire conductors of wires 522.

In operation, power plug 504 when connected to an external power source, provides power to each of overmolded LED lamps 400. Those skilled in the art will understand that external power source voltage is distributed equally amongst the plurality of overmolded LED lamps 400 of light string 502 when lamps 400 include substantially the same electrical characteristics.

In another embodiment, a decorative light string comprises a combination of parallel and series-connected overmolded LED lamps. In such a light string, the plurality of overmolded LED lamps comprise a first group and a second group of overmolded LED lamps, each of the first group and the second group comprising overmolded LED lamps electrically connected in an electrically series configuration, the first group being electrically connected to the second group in an electrically parallel configuration.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1-5. (canceled)

6. An overmolded light-emitting diode (LED) lamp for a decorative light string, comprising:
a light-emitting diode;
a first lead electrically connected to the light-emitting diode at a top portion of the first lead;
a second lead electrically connected to the first lead through the LED;
a lens encapsulating the light-emitting diode, a top portion of the first lead, and a top portion of the second lead; and
a housing having a solid uniform body encapsulating a bottom portion of the lens, a portion of the first lead, and a portion of the second lead, such that bottom portions of the first lead and the second lead extend outward and away from a bottom portion of the housing.

7. The overmolded LED lamp of claim 6 wherein the bottom portions of the first and second leads are configured to be in a common plane.

8. The overmolded LED lamp of claim 6 wherein the bottom portion of the first lead and the bottom portion of the second lead are positioned offset and oblique to each other such that a plane formed by the bottom portion of the first lead and a plane formed by the bottom portion of the second lead are parallel to one another.

9. The overmolded LED lamp of claim 6 wherein the bottom portion of the first lead and the bottom portion of the second lead are positioned adjacent and opposite to each other such that a plane formed by the bottom portion of the first lead and a planed formed by the bottom portion of the second lead are parallel to one another.

10. The overmolded LED lamp of claim 9, wherein the first lead includes a twisted portion such that the bottom portion of the first lead is rotated substantially 90° from a top portion, the twisted portion substantially encapsulated by the housing.

11. The overmolded LED lamp of claim 6, wherein the bottom portion of the first lead or the second lead comprises a wire-piercing portion.

12. The overmolded LED lamp of claim 6, further comprising a receiver for receiving the housing, such that the housing and the receiver are mechanically connected.

13. The overmolded LED lamp of claim 6, further comprising a first side contact positioned on one side of the housing and a second side contact positioned on the opposite side of the housing.

14. The overmolded LED lamp of claim 13, wherein the side contacts extend from the outer surface of the housing.

15. The overmolded LED lamp of claim 13, wherein the lens comprises an elongated lens, the elongated lens having a height at least the height of the housing.

16. A decorative light string, comprising:
a power plug for receiving electrical power from an external power source;
a plurality of overmolded light-emitting diode (LED) lamps, each of the plurality of LED lamps including:
an LED;
a first lead electrically connected to the LED;
a second lead electrically connected to the LED and the first lead;
a lens encapsulating the LED, a top portion of the first lead, and a top portion of the second lead; and
a housing having a solid uniform body encapsulating a bottom portion of the lens, a portion of the first lead, and a portion of the second lead, such that bottom portions of the first lead and the second lead extend outward and away from a bottom portion of the housing; and
a wire harness electrically connecting the power plug to the plurality of overmolded LED lamps and electrically connecting the plurality of overmolded LED lamps to each other.

17. The decorative light string of claim 16, wherein the plurality of overmolded LED lamps are electrically connected in an electrically parallel configuration.

18. The decorative light string of claim 17, wherein the wiring harness comprises a pair of side-by-side wires, including a first wire and a second wire, and wherein the first wire is electrically connected to the first leads of the plurality of overmolded LED lamps, and the second wire is electrically connected to the second leads of the plurality of overmolded LED lamps.

19. The decorative light string of claim 16, wherein the plurality of overmolded LED lamps comprise a first group and a second group of overmolded LED lamps, each of the first group and the second group comprising overmolded LED lamps electrically connected in an electrically series configuration, the first group being electrically connected to the second group in an electrically parallel configuration.

20. The decorative light string of claim 16, wherein the bottom portion of the first lead or the second lead of each of the plurality of overmolded LED lamps comprises a wire-piercing portion.

21. (canceled)

22. A light-emitting diode (LED) lead frame set, the set comprising:
a first lead frame having a first lead and a second lead;
a second lead frame immediately adjacent the first lead frame, the second lead frame having a first lead and a second lead;
a support structure having at least one support frame and a continuous base structure coupling the at least one support frame;
a crossbar coupling the first lead frame and the second lead frame; and
a plurality of sagittal supports, each sagittal support positioned along the same axis as the axes of each of the first and second leads and extending to the at least one support frame, thereby coupling the support structure to the individual leads.

23. The LED lead frame set of claim 22, wherein the crossbar is coupled at a first end intermediate the top of the first lead frame second lead and the bottom of the first lead frame second lead and at second end intermediate the top of the second lead frame first lead and the bottom of the second lead frame first lead.

24. The LED lead frame set of claim 22, further comprising a transverse support coupled intermediate the crossbar and extending to the at least one support frame.
